(19) United States
(12) Patent Application Publication
(10) Pub. No.: US 2009/0284814 A1
(43) Pub. Date: Nov. 19, 2009

(54) SETUP FOR STORING DATA IN A HOLOGRAPHIC STORAGE MEDIUM AND PHASE PLATE

(75) Inventors: Frank Jeroen Pieter Schuurmans, Eindhoven (NL); Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/294,258

(22) PCT Filed: Mar. 29, 2007
(86) PCT No.: PCT/IB07/51105

§ 371 Date: Sep. 24, 2008

(30) Foreign Application Priority Data
Mar. 29, 2006 (EP) 06300301.6

(51) Int. Cl. G03H 1/04

(52) U.S. Cl. 359/30

(57) ABSTRACT

The present invention relates to a setup for storing data in a holographic storage medium, said setup comprising a spatial light modulator (SLM) (18) and a phase plate (50), the spatial light modulator having a first pixel structure, the phase plate having a second pixel structure, and the first and the second pixel structures being aligned with each other, wherein a pitch of the second pixel structure is an integer multiple of a pitch of the first pixel structure, the integer multiple being strictly greater than 1.

### FIELD OF THE INVENTION

The present invention relates to a setup for storing data in a holographic storage medium and to a phase plate. The present invention particularly relates to data storage using a spatial light modulator (SLM).

### BACKGROUND OF THE INVENTION

In holographic data storage a two-dimensional spatial light modulator (SLM) pattern containing digital information (‘0’s and ‘1’s) is projected onto a holographic storage medium. The most common configuration is the so called 4 f Fourier configuration, in which the distance between the SLM and a first lens is one focal distance f₁ of this lens, the distance from this lens to the medium is f₁, the distance from the medium to a second lens is one focal distance f₂ of this second lens, and finally the distance from this second lens to a detector array is again f₂. Typically f₁=f₂.

An illustration of such a setup is given in FIG. 4. The light from a laser is directed towards a reflective spatial light modulator 18 (R-SLM, e.g. a LCoS device) by means of a polarizing beam splitter 26. The two-dimensional data page generated by the R-SLM is reflected back towards an imaging lens 22, which focuses the light into the holographic medium 110. This light interferes in the medium with the reference beam (not shown) and results in the refractive index modulation representing the data. During read out, the medium 110 is illuminated with the reference beam, resulting, by means of diffraction, in the reconstruction of the original data page wavefront. The diffracted light is imaged with a lens 24 onto the detector array 20 (e.g. CMOS or CCD array). Note that the distance from the SLM to the first lens 22 corresponds to the focal distance of this lens 22 and is equal to the distance from the lens 22 to the medium 110, the distance from the medium 110 to the second lens 24, as well as the distance from the second lens 24 to the detector array 20; hence the name 4 f configuration.

As can be seen from FIG. 4, the medium is in focus, with a spot size S roughly equal to S=(Kλ/NA)², where K² is the number of pixel in the SLM, λ is the wavelength of light, and NA=sinΘ is the numerical aperture of the lenses used. However, the intensity distribution through this focus is not homogenous, but is strongly peaked with a peak width of λ/NA and an intensity scaling with K⁴. In fact, the intensity distribution is the Fourier transform of the image on the SLM and the peak arises from the non-zero DC Fourier component. This peak does not carry any information on which of the pixels is ‘1’ and which is ‘0’, and is thus undesirable. Furthermore, the intensity of this peak (˜K⁴) is orders of magnitude larger than surrounding intensity (˜K²) and hence will burn the medium and/or introduce undesirable non-linearities in the refractive index modulation.

The most common solution of this problem is illustrated in FIG. 5, which is positioning the holographic recording layer not exactly in focus but out of focus. The optical system is now asymmetric as the material is placed eccentric. This is undesirable because of the additional wavefront aberrations that are introduced this way. In a fully symmetric design, Coma and Distortion are completely absent, hence a symmetric design is preferred.

As illustrated in FIG. 6, another known method of solving the problem is to use a random phase plate (RPP) 150 close to the SLM 18 (see for example H. J. Coufal et al, Holographic Data Storage, Springer Verlag (Berlin, 2000), pp 259-269). A random phase between 0 and 2π is introduced by the phase plate for each pixel of the SLM. Specifically, the sharp peaked intensity arises from coherent addition of all the ‘on’ pixels. If each of these pixels are given a random phase, the coherent addition adds up to zero and the peak disappears.

However, the problem with the random phase plate as shown in FIG. 6 is that the storage density is significantly lower with the phase plate than without it. The storage area S in focus is determined by the angular distribution θ_{diff} of light diffracted off the SLM-RPP combination and the focal length f of the first lens, i.e. S=˜(θ_{diff}*f)². In case of only the SLM, θ_{diff}=˜(λ/d_{SLM}), where d_{SLM} is the pixel size of the SLM. In case of the combination of the SLM and the random phase plate, θ_{diff}=˜(λ/d_{SLM})+(λ/d_{RPP}), where d_{RPP} is the ‘pixel’ size of the random phase plate. A hand waving argument for this is that the light is both diffracted off the SLM and the phase plate. Obviously, when d_{RPP}=d_{SLM}, the storage area involved is significantly larger than without phase plate and this results in a lower storage density.

It is therefore an object of the invention to provide a solution in order to avoid the undesired DC Fourier component without introducing additional wavefront aberrations and without significantly reducing the storage density of the holographic storage medium.

### SUMMARY OF THE INVENTION

The above objects are solved by the features of the independent claims. Further developments and preferred embodiments of the invention are outlined in the dependent claims.

In accordance with the invention, there is provided a setup for storing data in a holographic storage medium, said setup comprising a spatial light modulator (SLM) and a phase plate, the spatial light modulator having a first pixel structure, the phase plate having a second pixel structure, and the first and the second pixel structures being aligned with each other, wherein a pitch of the second pixel structure is an integer multiple of a pitch of the first pixel structure, the integer multiple being strictly greater than 1. The term “pitch” designates the distance between two points in neighboring pixel areas of the pixel structures that have the same relative position within the pixel areas. Thus, the pixel size of the phase plate can be significantly larger than the pixel size of the spatial light modulator. However, for each pixel of the spatial light modulator the phase should be uniform, i. e. phase transitions are not allowed at positions different from the junction between the neighboring pixels in the spatial light modulator. Otherwise, the intensity detected at the detector array for such a pixel could yield a low value whereas it should have been high because the light from the two parts of the pixels having different phases interfere at the detector and cancel each other. Hence the requirement of an alignment of the pixel structures which means that transitions in phase may occur only at the edges of the SLM pixel structure.

Preferably, the integer multiple is smaller than 32.

More preferably, the integer multiple is between 2 and 16.

Advantageously, the integer multiple is 8.

The choice of the integer multiple depends on the specific requirements. While choosing a large value for the integer multiple results in an advantageous separation of the peaks in the intensity spectrum of the detector array, a small value of the integer multiple leads to a better reduction of the DC Fourier component. Thus, taking into account the spatial filter properties, the optimum value of the integer multiple is the result of an evaluation of the counter acting effects as to the peak separation in the intensity spectrum and the desired smearing out of the DC Fourier component.

Preferably, the pixel structure of the phase plate comprises a first set of pixels representing a first digital value and second set of pixels representing a second digital value, the number of pixels in the first set being essentially identical to the number of pixels in the second set. Thus, a binary phase plate is suggested with only two phases, 0 and π. This is in contrast to a “continuous” phase plate having any value between 0 and 2 π. Such a binary phase plate is easy to manufacture. The master that can be used to replicate such a phase plate is easily made in a few processing steps, namely spin coating a photo resist onto a substrate, illuminating the structure with an appropriate pattern, and etching the binary structure. By making this phase plate balanced, i. e. providing it with a more or less equal area of 0 phase and π phase, the coherent addition of the phases adds up to zero.

According to a preferred embodiment of the invention the pixel structure of the phase plate is a quasi-random structure. Thus, the phase plate is a random phase plate as suggested in prior art.

According to a different preferred embodiment, the pixel structure of the phase plate is an arranged structure. In contrast to the random phase plate an arranged phase plate has some kind of regularity. For example, the phase plate is shaped similar to a phase grating in which the phase alternates between 0 and π. In this case of an arranged structure, the DC Fourier component is diffracted into the different diffraction orders of the grating. This is in contrast to the random phase plate where the light is not diffracted into several discrete diffraction orders but smeared over a substantial angular range.

According to a particular embodiment, the phase plate is arranged as a phase plate separate from the spatial light modulator.

According to a different embodiment, the phase plate is integral with the spatial light modulator. In the case of the phase mask integral with the spatial light modulator, a very precise alignment of the pixel structure is possible and provided on the basis of the integral structure. Thus, no misalignment is to occur in a setup using such an integral solution.

According to a further aspect of the present invention there is provided a phase plate capable of being used in a setup for storing data in a holographic storage medium, said setup comprising a spatial light modulator (SLM) and a phase plate, the spatial light modulator having a first pixel structure, the phase plate having a second pixel structure, and the first and the second pixel structures being aligned with each other, wherein a pitch of the second pixel structure is an integer multiple of a pitch of the first pixel structure, the integer multiple being strictly greater than 1.

These and other aspects of the invention will be apparent from and elucidated with reference to the embodiments described hereinafter.

### BRIEF DESCRIPTION OF THE DRAWINGS

FIG. 1 shows a schematic illustration of a spatial light modulator with a phase plate according to the present invention.

FIG. 2 shows an intensity distribution for a setup without phase plate and for a setup with a random phase plate according to the present invention.

FIG. 3 shows intensity spectra for different phase plates.

FIG. 4 shows a setup of a holographic data storage device according to prior art.

FIG. 5 shows a setup of a holographic data storage device according to prior art.

FIG. 6 shows a schematic illustration of a spatial light modulator with a phase plate according to prior art.

### DESCRIPTION OF PREFERRED EMBODIMENTS

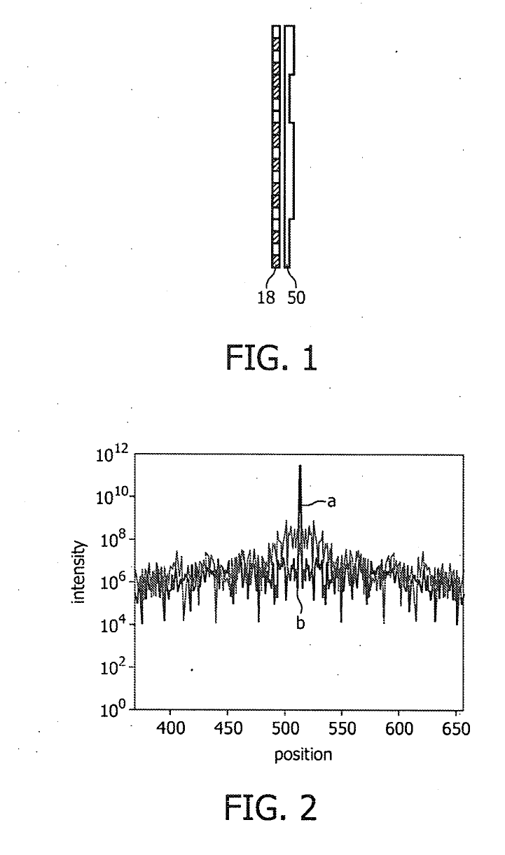

FIG. 1 shows a schematic illustration of a spatial light modulator 18 with a phase plate 50 according to the present invention. In contrast to the phase plate 150 according to prior art as illustrated in FIG. 6, the phase plate 50 according to the present invention does not vary its phase for each pixel of the spatial light modulator, but larger blocks of pixels. In this exemplified case, the integer multiple by which the pitch of the phase mask is larger than the pitch of the spatial light modulator is 4. Note that the variation of the pixel structure is shown only in one dimension. The variation in the perpendicular dimension can be equal or different. In any case, the edges of the phase plate pit structure are aligned with the edges of the modulator pit structure, i. e. no modulation change occurs within a pixel of the spatial light modulator. Further note that the pitch of the pixel structure in the phase plate may be constant or variable in either dimension.

FIG. 2 shows an intensity distribution for a setup without phase plate and for a setup with a random phase plate according to the present invention. The position through the focus is plotted on the x-axis, and the intensity is plotted on the y-axis. The intensity distribution denoted with (a) is the distribution without a phase plate, while the distribution denoted (b) is with a random phase plate in accordance with the present invention. The curve (a) is sharply peaked, while the curve (b) shows no strong peak. Thus, the DC Fourier component is suppressed on the basis of the present invention.

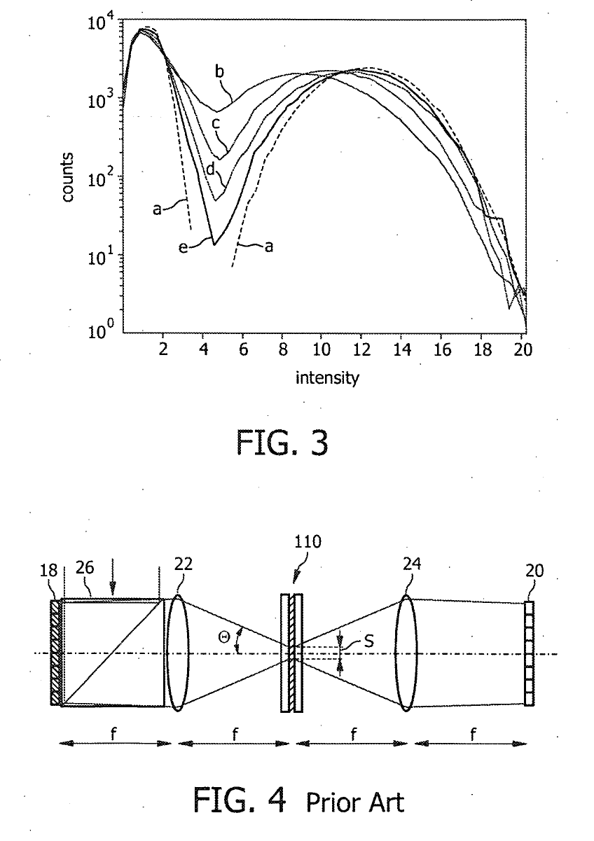

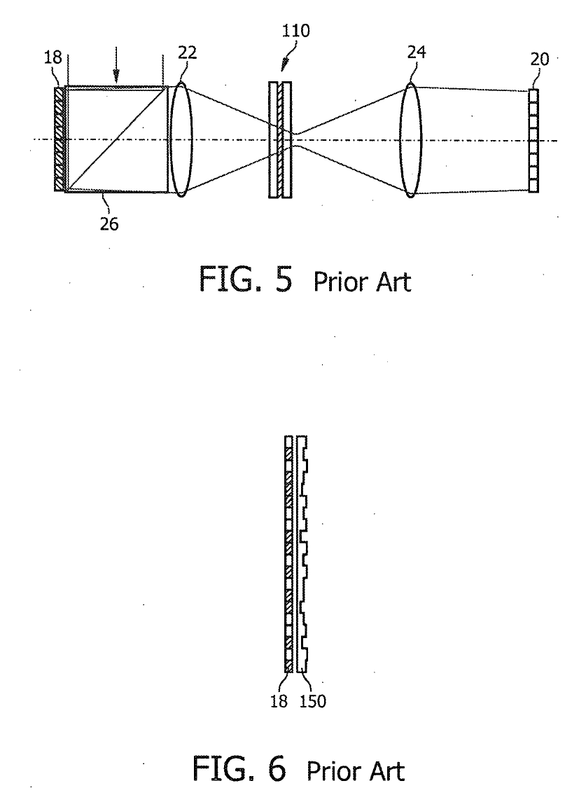

FIG. 3 shows intensity spectra for different phase plates. The different intensity spectra shown in FIG. 3 all have a double peaked structure, one of the peaks representing a digital ‘0’ and one representing a digital ‘1’. The curves (a) correspond to a setup without phase plate. Curve (b) corresponds to a phase plate with an integer multiple between the phase plate pixel structure and the modulator pixel structure of 1, i. e. a setup in accordance with prior art. The curves (c), (d), and (e) correspond to pitch ratios of 2, 4, and 8, respectively. As can be seen, the peaks for the situation without a phase plate are distinct. In contrast thereto, for a spatial light modulator with a phase plate according to prior art, i. e. with a pitch ratio of 1, the peaks show a largely overlapping behaviour (curve (b)). For a given spatial filter, e. g. 1.125 times the Nyquist limit representing the area in the focal plane that is needed to just be able to distinguish the ‘0’ and ‘1’ on the detector array, the values ‘0’ and ‘1’ are not well distinguishable in the case of curve (b), and a lot of bit detection errors are introduced. This could be solved by increasing the spatial filter size, however, this would be at the expense of storage capacity. Instead, it is also possible to increase the pitch ratio of the phase plate, for example from 1 (curve (b)) to 8 (curve (e)). Consequently, for a pitch ratio of for example 8, the bit error rate is hardly affected, also maintaining an almost unaffected storage density. It should be noted that this does not mean that the pitch ratio should be increased to larger and larger values, since the smearing out effect of the DC Fourier component works better with smaller pitch ratios. A hand waving argument for this is that increasing the pitch ratio to infinity leads to a phase plate without any structure, thus corresponding to a spatial light modulator without phase plate that has a strong DC Fourier component. Consequently, an optimum value for the pitch ratio has to be determined for the particular setup given.

Equivalents and modifications not described above may also be employed without departing from the scope of the invention, which is defined in the accompanying claims.

1. A setup for storing data in a holographic storage medium, said setup comprising a spatial light modulator (SLM) (18) and a phase plate (50), the spatial light modulator having a first pixel structure, the phase plate having a second pixel structure, and the first and the second pixel structures being aligned with each other, wherein a pitch of the second pixel structure is an integer multiple of a pitch of the first pixel structure, the integer multiple being strictly greater than 1.

2. The setup according to claim 1, wherein the integer multiple is smaller than 32.

3. The setup according to claim 1, wherein the integer multiple is between 2 and 16.

4. The setup according to claim 3, wherein the integer multiple is 8.

5. The setup according to claim 1, wherein the pixel structure of the phase plate (50) comprises a first set of pixels representing a first digital value and second set of pixels representing a second digital value, the number of pixels in the first set being essentially identical to the number of pixels in the second set.

6. The setup according to claim 1, wherein the pixel structure of the phase plate (50) is a quasi-random structure.

7. The setup according to claim 1, wherein the pixel structure of the phase plate (50) is an arranged structure.

8. The setup according to claim 1, wherein the phase plate (50) is arranged as a phase plate separate from the spatial light modulator.

9. The setup according to claim 1, wherein the phase plate is integral with the spatial light modulator.

10. A phase plate capable of being used in a setup for storing data in a holographic storage medium, said setup comprising a spatial light modulator (SLM) (18) and a phase plate (50), the spatial light modulator having a first pixel structure, the phase plate having a second pixel structure, and the first and the second pixel structures being aligned with each other, wherein a pitch of the second pixel structure is an integer multiple of a pitch of the first pixel structure, the integer multiple being strictly greater than 1.
